(19) United States
(12) Patent Application Publication
(10) Pub. No.: US 2019/0151858 A1
(43) Pub. Date: May 23, 2019

(54) METHOD FOR SEPARATION OF COATING FROM COATED GLASS WASTE AND APPARATUS SUITABLE FOR THIS PURPOSE

(71) Applicant: Mijndert Cornelis Ernst Ralf Creteer, Goirle (NL)

(72) Inventor: Mijndert Cornelis Ernst Ralf Creteer, Goirle (NL)

(21) Appl. No.: 15/819,583

(22) Filed: Nov. 21, 2017

(51) Int. Cl. B02C 23/10; B02C 23/02; B02C 23/14; B03C 1/18; B07B 4/00

(52) U.S. Cl. CPC B02C 23/10; B02C 23/02; B03C 2201/20; B03C 1/18; B07B 4/00; B02C 23/14

(57) ABSTRACT

The current invention, in a first aspect, concerns a method for separating a lead component from a lead coated glass, for instance glass from a CRT recycling process. The coated glass is crushed and ground to achieve a finely grained material of a mixture of a glass fraction and a lead fraction. The lead fraction is separated from the glass fraction based upon a difference in specific weight and/or density. In a second aspect the current invention concerns an apparatus for separating a lead component from a lead coated glass, for instance glass from a CRT recycling process. The apparatus is provided with a grinding unit. The apparatus includes a separator unit suited for separation based upon a difference in specific weight and/or density.

### TECHNICAL FIELD

The invention pertains to the technical field of coated glass recycling. The current invention relates to a method for removing a coating from glass, and more particularly a method suitable for removing a lead coating from the inside surface of a funnel of a cathode ray tube (CRT).

### BACKGROUND

About a decade ago, CRTs were frequently used, inter alia, in televisions, computer monitors and monitors for specialist applications, for example, in cash dispensers and industrial applications. A CRT generates images by the acceleration of electrons towards a fluorescent screen. Nowadays, monitors are using more advanced and modern technologies like, among others, liquid crystal displays (LCD), thin film transistor liquid crystal displays (TFT) and organic light emitting diode displays (OLED). With almost no outlets for leaded CRT glass, hundreds of thousands of tons are being accumulated in warehouses across the U.S. alone.

A typical CRT is made from a lead-free screen glass and a funnel glass containing approximately 20% lead, the two being joined by a glass solder containing up to 90% lead. The lead acts to improve the optical quality of the glass and to shield the user from X-ray radiation emitted during the electron bombardment of the screen, as disclosed in WO 2014/125266 A1. Whilst this lead glass performs a useful role within a CRT, it poses a substantial environmental risk when the CRT reaches the end of its life and is disposed of. Studies have shown that when CRTs are disposed of in landfill sites, lead can leach from the glass and contaminate ground water. The severity of the environmental risk is such that the disposal of CRTs is regulated by legislation in many countries.

When a screen is separated from a funnel section for recycling, as disclosed in WO 03/081626 A1, the coating must be removed before the glass in the screen can be recycled. This is usually achieved by the coating being brushed by hand by an operator, and the dust removed by a vacuum hose. This exposes the operator to an environment in which there are airborne heavy metals, which are dangerous to health. The method is also labor intensive, slow and therefore expensive. It is widely appreciated that CRTs should be disposed of in a controlled environment which minimizes the risk to health. There is therefore a need to provide a method for removing the coating on the inside of the funnel, for the glass and lead coating to be effectively recycled and/or reused.

Methods known to date for removing the layer and other coated material from CRTs have been achieved by different types of processing methods that effect the removal. Compare, for example, DE 4241331 C1 that shows and describes a technique comprising water blasting and filtering and DE 4133732 C2 that describes a method for removing lead by processing with ultrasound.

A procedure for recycling coated glass, for example CRT, where the glass is crushed, separated into different fractions in the form of glass and metal and mixed in a mixing unit for a predetermined period of time during which a liquid circulates through the mixing unit is known from U.S. Pat. No. 5,316,510. According to the procedure, the coating is removed from the glass by the removal effect that is obtained as a result of the tumbling in the mixing unit. The coatings are collected from the circulating liquid by filtering. However, this known method has the disadvantage that it does not allow the release of particles that adhere firmly in the glass or that are in principle enclosed in the glass.

The disadvantage of methods known to date for recycling coated glass is that they do not permit a level of purity of the glass such that it can be recycled and be used in a real recycling chain, as disclosed in EP1154860 A1.

The aim of the present invention is thus to achieve an improved procedure that makes it possible to remove lead from coated glass with a very high level of purification and thereby also allowing the complete recycling of said glass and lead.

### SUMMARY OF THE INVENTION

These goals are achieved by a method according to a first aspect of the present invention, having the features and characteristics stated in claim 1. The described method comprises the grinding of lead coated glass to a finely grained material of a mixture of a glass fraction and a lead fraction, followed by a separation of said lead fraction from said glass fraction based upon a difference in specific weight and/or density.

A further embodiment of the invention comprises a processing step using an air flow and/or air turbulence, thus enhancing separation efficiency.

In a further embodiment of the invention the coated glass is ground to a specific particle size. Preferably the particle size is 15 to 40 μm, more preferably 20 to 35 μm, more preferably 20 to 30 μm and even more preferably 23 to 27 μm. These particle sizes have shown to yield the most efficient separation and also show the most potential for reuse purposes.

A further embodiment of the invention is the grinding of the coated glass to be achieved by using a grinding unit comprising a grinding mill. Preferably, this grinding mill comprises steel marbles. Grinding achieved by said mill comprising steel marbles yields the best results in the desired particle size range.

In a further embodiment of the invention, separation is further enhanced by applying an eddy current before, during or after the separation. As lead is a non-ferrous metal, separation of lead and other inert materials, like glass, can be improved by applying an eddy current to the mixture, whereby the lead fraction can be more efficiently withheld.

In a second aspect of the current invention, an apparatus for separating a lead fraction from a lead coated glass, whereby the coated glass is crushed and ground to achieve a finely grained material of a mixture of a glass fraction and a lead fraction, comprises a separator unit for separating the lead fraction from the glass fraction based upon a difference in specific weight and/or density.

In a further embodiment of the invention, said apparatus comprises a separator unit whereby a wind flow and/or wind turbulence is applied. Preferably said separator unit also comprises a vacuum generator and a non-ferrous separator. The advantage of implementing these elements is a far more efficient separation.

In a further embodiment of the invention, said apparatus comprises a grinding mill, preferably comprising steel marbles, a conveyer belt for the automated supply of coated glass and two or more storage containers for the storage of said glass fraction and said lead fraction. Implementation of these components has the advantage of fully automating the process executed with said apparatus.

In a third aspect, the present invention concerns a plant for recycling waste CRT material.

### BRIEF DESCRIPTION OF THE DRAWINGS

FIG. 1 shows a schematic overview of a CRT recycling process, wherein the current invention, comprising a grinding unit and a separation unit, is implemented;

FIG. 2 shows a schematic cross sectional view of the separator unit, in accordance with the invention;

FIG. 3a shows a schematic cross sectional view of an embodiment of the grinding unit, in accordance with the invention;

FIG. 3b shows a schematic cross sectional view of another embodiment of the grinding unit, in accordance with the invention; and

FIG. 4 shows a schematic cross sectional view of an embodiment of the non-ferrous separator along a conveyor belt.

### DETAILED DESCRIPTION OF THE PREFERRED EMBODIMENT

In a first aspect, the present invention concerns a method comprising the grinding of lead coated glass to a finely grained mixture of a lead fraction and a glass fraction, followed by a separation of said lead fraction from said glass fraction based upon a difference in specific weight and/or density.

In a second aspect, the present invention concerns an apparatus suitable for this purpose.

In a third aspect, the present invention concerns a plant for recycling waste CRT material.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

In a first aspect the current invention provides a method, comprising the grinding of lead coated glass to a finely grained material of a mixture of a glass fraction and a lead fraction, followed by a separation of the lead fraction from the glass fraction based upon a difference in specific weight and/or density. The advantage of this separation process lays in the fact that it is a dry process, i.e. no leaching agents or other liquids are required, resulting in a simple process with a high yield, which is moreover completely automated and thus very fast and efficient in comparison to other known processes. Moreover, the process provided by the first aspect of the current invention has the advantage of being more environmentally friendly and more safe regarding the health of employees and/or other bystanders in comparison to other known processes.

A further embodiment of the invention comprises a processing step using an air flow and/or air turbulence, which is applied before, during or after separation. Air speeds need to be carefully regulated in order to obtain a high separation yield. By applying said air flow and/or air turbulence, the separation of the lead fraction from the glass fraction occurs in a faster and more reliable way. More specifically the air flow is able to blow the glass fraction out of the separator unit, whilst the lead fraction can fall through e.g. a mesh-like structure, thus catching the glass and lead fractions in separate containers.

By preference, the particle size of the grinded material is 15 to 40 μm, more preferably 20 to 35 μm, more preferably 20 to 30 μm and even more preferably 23 to 27 μm. The inventors found that a particle size range as described above was particularly useful when separating.

A further embodiment of the invention uses vacuum conditions to enhance separation. By combining an air flow and vacuum conditions during separation, the lighter glass fraction is blown and sucked out of the mixture, while the lead fraction can fall through e.g. a mesh-like structure, thus improving the separation speed and efficiency.

A further embodiment of the invention is the grinding of the coated glass to be achieved by using a grinding unit comprising a grinding mill. Said grinding of the coated glass may be achieved by known devices in the prior art. Preferably, said grinding mill may be provided with grinding aids in order to enhance the grinding process. Such grinding aids could be spherical objects such as steel marbles. The inventors found that by grinding the coated glass in said grinding mill, the desired particle size range was consistently achieved, moreover, the presence of these grinding aids showed to enhance the removal of lead coating from the lead coated glass, thus improving the purity of the separated fractions.

In a further embodiment of the invention, separation is further enhanced by applying an eddy current before, during or after the separation. As lead is a non-ferrous metal, separation of lead from other inert materials, like glass, can be improved by applying an eddy current to the mixture. By applying an eddy current the lead fraction is temporarily magnetized and repelled by the non-ferrous separator, thus separated from the inert glass fraction, which does not respond to the eddy current.

Combining all of the above characteristics yields a separation method that meets al required specifications, whereby an efficiency of at least 90%, or preferably at least 95% is achieved.

In a second aspect of the current invention, an apparatus for separating a lead fraction from a lead coated glass, whereby the coated glass is crushed and ground to achieve a finely grained material of a mixture of a glass fraction and a lead fraction, comprises a separator unit for separating the lead fraction from the glass fraction based upon a difference in specific weight and/or density. Said apparatus has no need for the addition of liquids, like a leaching agent, which makes it easy to maintain and clean.

In a further embodiment of the invention, said apparatus comprises a wind flow and/or wind turbulence generator in the separation unit. Preferably said separator unit also comprises a vacuum generator. Both generators are fully adjustable with the aim of regulating the ideal air flow and vacuum conditions to obtain a high yield separation. By applying both a wind flow and a vacuum, the apparatus is specifically suited for the separation of a lead coating fraction from a glass fraction, whereby the glass fraction is sucked out of the mixture unit whilst the lead fraction is able to fall through e.g. a mesh-like structure.

A further embodiment of the invention comprises a separator unit provided with a non-ferrous separator. Said non-ferrous separator is suited for the generation of an eddy current inside the separator, which can temporarily magnetize said lead fraction. Said lead fraction is repelled by the non-ferrous separator, thus efficiently directing it to a lead fraction outlet, while the glass fraction is being sucked out of the mixture towards a glass fraction outlet.

In a further embodiment of the invention, said apparatus comprises a grinding mill, preferably comprising steel marbles, a conveyer belt for the automated supply of coated glass and two or more storage containers for the storage of said glass fraction and said lead fraction. The availability of steel marbles in the grinding unit ensures the fast and efficient grinding of a supplied mixture of a lead fraction and a glass fraction. Moreover, the steel marbles are essential for the removal of the lead coating from the coated glass, thus obtaining more pure separated end products which are collected in the separate containers.

In a third aspect of the current invention, a plant for recycling waste CRT material comprises a crusher unit, a trumble unit, an X-ray separator, a grinding unit, a dedicated separator unit, storage containers, whereby all elements, parts or units are interconnected via conveyor belts and pipes and whereby the separator unit is suited for separation based upon a difference in specific weight and/or density, said separator being provided with a speed adjustable wind flow and/or wind turbulence generator, a vacuum generator and an optional non-ferrous separator.

The invention is further described by the following non-limiting examples which further illustrate the invention, and are not intended to, nor should they be interpreted to, limit the scope of the invention.

### DESCRIPTION OF FIGURES

For a better understanding of the present invention, and to show more clearly how it may be carried into effect, reference will now be made, by way of example, to the accompanying drawings.

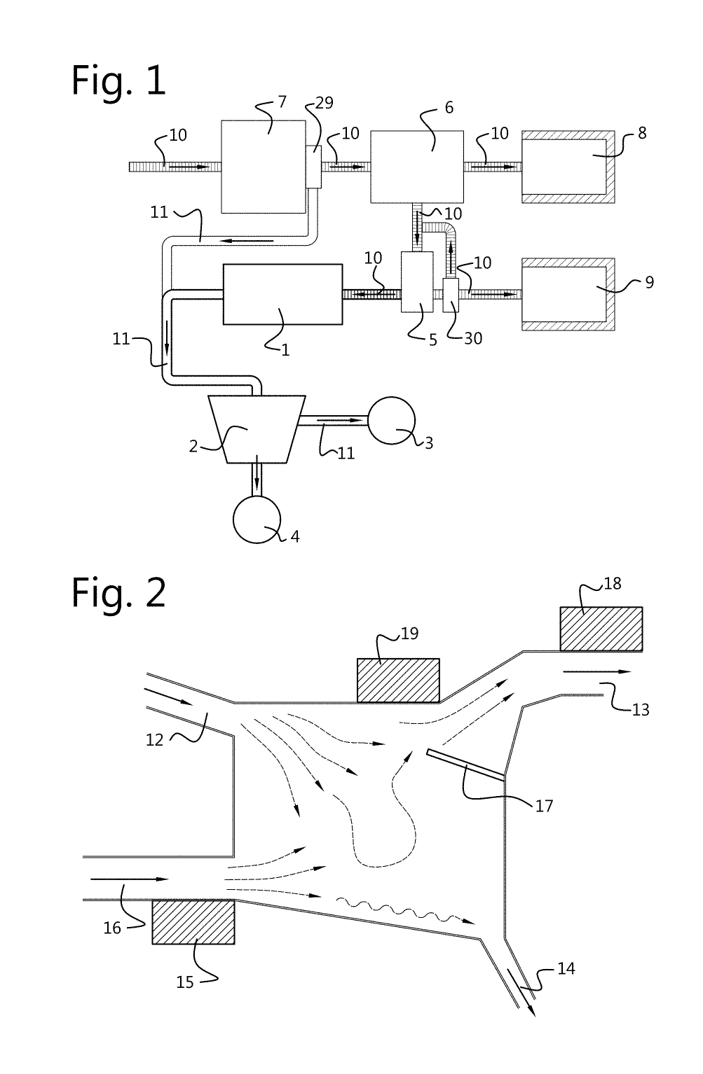

Referring to FIG. 1, a schematic overview of a CRT recycling process is shown, wherein the current invention, comprising a grinding unit 1 and a separator unit 2 are implemented. Crushed CRT glass is fed to the grinding unit by a conveyor belt 10. The ground CRT glass leaves the grinding unit via pipe 11, to be consequently fed to the separator unit. The separator unit separates the ground CRT glass into two fractions, whereby a glass fraction and a lead fraction are stored in respectively container 3 and 4. Prior to the grinding unit and the separator unit, an X-ray separator 5 with analysis unit 30, a trumble unit 6 and a crusher unit 7 provided with a dust extraction system 29 are present, all being interconnected via conveyor belts 10. Although the X-ray separator, the trumble unit and the crusher unit are not explicitly part of the current invention, they ensure the correct supply of crushed CRT glass to the grinding unit by crushing CRT screens, trumbling out materials other than crushed CRT glass or crushed glass without coating, which could e.g. be metal frames, and by separating crushed glass without coating from crushed CRT glass. The non-glass material and the crushed glass without coating are stored in containers 8 and 9 respectively.

In FIG. 2 a schematic cross sectional view of separator unit 2 is shown with more detail. The separator unit comprises the following in- and outlets: an inlet for the ground CRT glass 12, an inlet for an air flow and/or air turbulence 16, an outlet for the resulting lead fraction 14 and an outlet for the resulting glass fraction 13. The separation takes place on the basis of a difference in specific weight and/or density of both the lead fraction and the glass fraction. To aid this separation, an air flow and/or air turbulence generator 15, a vacuum generator 18 and a non-ferrous separator unit 19 are implemented in the separator unit. The ground CRT glass is supplied to the separator unit via inlet 12 while air is vigorously blown into the separator via inlet 16. At the same time a vacuum is applied on the outlet 13 by the vacuum generator 18. The combination of the air flow and/or air turbulence and the vacuum, enhances separation of the lead fraction from the glass fraction by sucking out the lighter glass particles, while the heavier lead particles are able to fall through the outlet 14. In the separation unit, a separator plate 17 is mounted near the glass/vacuum outlet 13, thereby improving the separation efficiency. To even more improve the separation efficiency a non-ferrous separator unit 19 is implemented, which generates an eddy current. Upon application of the eddy current, lead particles are temporarily magnetized and are repelled to the bottom side of the separator unit. As glass particles are not being influenced by this eddy current, they are easily sucked out of the separator via the outlet 13 while lead particles are even more strongly withheld, thus forced to fall through the outlet 14.

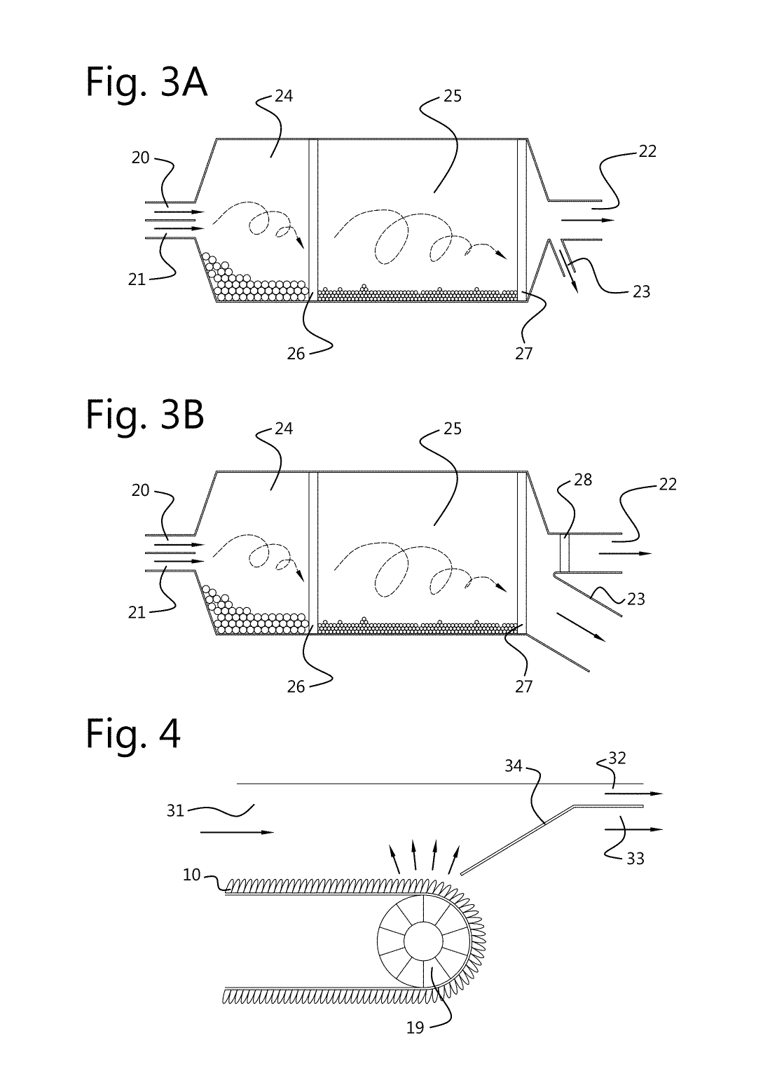

In FIG. 3a a schematic cross sectional view of grinding unit 1 is shown with more detail. The grinding unit comprises the following in- and outlets: an inlet for the crushed CRT glass 20, an air inlet 21, an air outlet 22 and an outlet for the ground CRT glass 23. The grinding unit comprises two chambers, a primary chamber 24 and a secondary chamber 25 in which the CRT glass is ground to the desired particle size. In the primary chamber the CRT glass is ground to an intermediate particle size which can pass the intermediate diaphragm 26. Small enough particles can pass to the secondary chamber where the grinding process continues in the presence of steel marbles. The steel marbles ensure both an even smaller resulting particle size, and an efficient removal of lead coating from the lead coated particles. Only ground glass and lead particles within the desired size range are able to pass the outlet diaphragm 27, and are consequently fed via the outlet 22 to the separator unit 2. A cross sectional view of another embodiment of this grinding unit is shown in FIG. 3b. The grinding unit is provided with a larger ground CRT glass outlet 23 and a second outlet diaphragm 28, which allows only the passage of air through outlet 22.

FIG. 4 shows a schematic cross sectional view of an embodiment of the non-ferrous separator 19 along a conveyor belt 10. By transport on the conveyor belt and/or carried by air, finely ground CRT glass enters the non-ferrous separator via inlet 31. While glass particles are carried underneath the separator shield 34 by the conveyor belt 10, thus leaving the non-ferrous separator via outlet 33, lead particles are temporarily magnetized and repelled by the non-ferrous separator, thus being carried above the separator shield 34 and leaving the separator via outlet 32 carried by a stream of air.

### Example

Separating and Isolating a Glass and a Lead Fraction Out of a Discarded CRT Television.

The example is explained referring to a CRT recycling plant as schematically shown in FIG. 1.

A discarded CRT television is delivered to a CRT recycling plant. This CRT television is a complex device that has to undergo some manual steps before supplying it to the fully automated CRT recycling process. These manual steps comprise removal of the plastic housing from the device and removal of the main electrical wiring parts. The CRT tube, still containing some metal and plastic elements that are more difficult to remove, is now supplied to the CRT recycling plant by putting it on the first conveyor belt. The CRT tube is carried into a crusher unit where the CRT rube is crushed in smaller parts. CRT glass dust, which can originate from the crushing step, is extracted by a dust extraction system. The resulting parts of the crushing step are not particularly small, however small enough to distinguish between several main materials. On the output conveyor belt of the crusher unit, different pieces of coated glass, glass, metal, plastic are spread out and supplied to a trumble unit. This trumble unit seperates the glass and coated glass pieces from other materials like metal and plastic, by allowing the glass and coated glass to fall through the trumble screen, i.e. a mesh or sieve, while withholding the metal and plastic pieces. A conveyor belt transports the metal and plastic pieces to a designated storage container while the glass and coated glass is transported via another conveyor belt to an X-ray separator, comprising an analysis unit, provided with an X-ray source and an X-ray camera in order to identify the leaded glass and separate it through an air flow. Lead and glass fractions are recirculated through the X-ray separator and its analysis unit until certain purity is achieved. Glass that does not contain any lead coating is transported to a designated storage container, while the leaded glass pieces are led to a grinding unit. This grinding unit comprises of steel marbles and further downsizes the leaded glass pieces. While downsizing, the steel marbles also have the effect of separating the lead coating from the glass. Two diaphragms allow only glass and lead particles of specific sizes to pass through. The outlet diaphragm is dimensioned for 25 μm particles or smaller, which is the desired particle size for the efficient separation of lead particles from glass particles. The mixture of particles is carried by an air flow tube to a separator unit. This separator unit separates the lead fraction from the glass fraction by applying three principles: air turbulence, vacuum suction and non-ferrous separation. The air turbulence, combined with the vacuum suction is able to blow the lighter glass particles out of the separator while the eddy current, generated by the non-ferrous separator, is enabling the temporary magnetization of the lead fraction, thus direction said lead fraction to the bottom side of the separator unit. This way, glass is removed from the separator at the top while lead is removed at the bottom, both fractions carried to a designated storage container.

It is supposed that the present invention is not restricted to any form of realization described previously and that some modifications can be added to the presented example of fabrication without reappraisal of the appended claims.

What is claimed is:

1. Method for separating a lead component from a lead coated glass, which comprises crushing the coated glass and grinding to achieve a finely grained material of a mixture of a glass fraction and a lead fraction, and separating the lead fraction from the glass fraction based upon a difference in specific weight and/or density.

2. Method according to claim 1, wherein said separation on the basis of specific weight and/or density occurs by applying a processing step comprising air flow and/or air turbulence, thereby separating said glass fraction from said lead fraction.

3. Method according to claim 1, wherein said resulting mixture of glass fraction and lead fraction has a particle size of 15 to 40 μm.

4. Method according to claim 1, wherein said resulting mixture of glass fraction and lead fraction has a particle size of 20 to 35 μm.

5. Method according to claim 1, wherein said separation on the basis of specific weight and/or density is further enhanced by applying a vacuum.

6. Method according to claim 1, wherein the grinding of the coated glass is achieved by using a grinding unit comprising a grinding mill.

7. Method according to claim 1, wherein said grinding of the coated glass is achieved by using said grinding mill, comprising a grinding aid.

8. Method according to claim 1, further comprising applying an eddy current before, during or after said separation, whereby said lead fraction is being magnetized temporarily.

9. Method according to claim 1, wherein said separation meets all required specifications, wherein an efficiency of at least 90% is achieved for said separation of the lead fraction from the glass fraction.

10. Apparatus for separating a lead component from a lead coated glass said apparatus comprising a grinding unit, and a separator unit suited for separation based upon a difference in specific weight and/or density.

11. Apparatus according to claim 10, wherein said separator unit comprises a speed adjustable wind flow and/or wind turbulence generator.

12. Apparatus according to claim 10, wherein said separator unit comprises a vacuum generator.

13. Apparatus according to claim 10, wherein said separator unit is provided with a non-ferrous separator suited for the induction of an eddy current inside the separator unit.

14. Apparatus according to claim 10, wherein said apparatus comprises a conveyor belt as input of said grinding unit, multiple pipes as input and output of said separator unit and two or more storage containers.

15. Plant for recycling waste CRT material, wherein said plant comprises a crusher unit, a trumble unit, an X-ray separator, a grinding unit, a dedicated separator unit, and storage containers, wherein all elements, parts or units are interconnected via conveyor belts and pipes and wherein the separator unit is suited for separation based upon a difference in specific weight and/or density, said separator being provided with a speed adjustable wind flow and/or wind turbulence generator, a vacuum generator and an optional non-ferrous separator.

16. The method of claim 1, wherein the lead coated glass is from a CRT recycling process.

17. The method of claim 4, wherein said resulting mixture of glass fraction and lead fraction has a particle size of 20 to 30 μm.

18. The method of claim 9, wherein the efficiency is at least 95%.

19. The apparatus of claim 10, wherein the lead coated glass is from a CRT recycling process.
